(19) United States
(12) Patent Application Publication
(10) Pub. No.: US 2014/0335261 A1
(43) Pub. Date: Nov. 13, 2014

(54) DE-ACIDIFICATION OF FATS AND OILS

(71) Applicant: ALFA LAVAL CORPORATE AB, Lund (SE)

(72) Inventors: Bent Sarup, Fredensborg (DK); Danilo Marques De Lima, Sao Paulo (BR)

(21) Appl. No.: 14/360,240

(22) PCT Filed: Nov. 1, 2012
(86) PCT No.: PCT/EP2012/071666

§ 371 Date: May 22, 2014

(30) Foreign Application Priority Data
Nov. 23, 2011 (EP) 11190313.4

(51) Int. Cl. A23D 9/04

(52) U.S. Cl. CPC A23D 9/04
USPC 426/601

(57) ABSTRACT

The present invention relates to a method for treating vegetable oils and/or animal fats comprising a vacuum steam stripping operation, condensing the neutral oils from vapour phase at an elevated temperature, retaining and sending back to the stripping column, allowing steam, volatile fatty acids, micronutrients together with other volatiles to pass to a cold condensation zone, and condensing the volatile fatty acids, micronutrients together with other volatiles in the cold condensation zone, producing a condensate and a stream of steam, non-condensable gases along with traces of fatty acids and other lighter hydrocarbons vapours. The invention may include a distillation step, either between the high and low temperature condensation zones or following the cold condensation zone.

The present invention relates to a new method for treating vegetable oils and/or animal fats.

### BACKGROUND

Most edible oils go through refining operations comprising pretreatment steps known as degumming and/or neutralisation, most often followed by treatment with a solid adsorbent, e.g. acid activated clay, known as bleaching. Pretreatment of oils for non-edible use, such as manufacture of biodiesel, may or may not include the bleaching operation. The pretreated oil is subsequently subjected to a high temperature operation known as deodorization. Deodorisation is conducted under vacuum and consists in general of two main process steps, a “heat bleaching” step, typically conducted within a range from about 240 to about 270° C. within 0.5 to 1.5 hrs retention time and a second step consisting of stripping of volatiles by the use of steam. Pretreatment of oil for non-edible use such as biodiesel manufacture does normally not include the heat bleaching step. Steam stripping, also known as de-acidification, of fats and oils, comprises reduction of free fatty acid (FFA) content by stripping with steam under vacuum. Volatiles are mainly those present in the pretreated oil, but volatiles may also be formed during the deodorisation operation, e.g. at the heat bleaching step. Steam stripping of volatile components may take place before, during or after the heat bleaching step. An example of deodorisation conducted by steam stripping in combination with heat bleaching is disclosed by WO 98/00484. Simultaneously with the removal of FFA, the steam stripping action will also partly remove valuable components such as micronutrients including tocopherols, sterols, squalene as well as “neutral oils”, i.e. tri-, di- and mono-acylglycerides (TAG, DAG, MAG), which represents a loss of valuable main product. Volatiles are condensed in a cold condensation zone before the stripping steam along with non-condensable gases (e.g. inleakage air) are being lead to the vacuum system. Such a cold condensation zone commonly operates within a range from about 40 to about 60° C. and is commonly implemented as a scrubber loop, where cold distillate is used to condense the volatiles. The cold distillate will, besides the FFA:s, also contain micronutrients and “neutral oils”. Due to the high value of the micronutrients there is particular interest in recovering those from the distillate. However, the micronutrients need to be enriched in their concentration in the plant so that their further processing in purification plants and transport to such plants can take place in an economical manner. The loss of “neutral oils” will further dilute any enriched stream of micronutrients that can be withdrawn from the system.

A current trend in the edible oil industry is to use certain enzymes, commonly known as phospholipase A (“PLA”) type enzymes, to enable removal of phosphorous containing components (“phospholipids”) of the crude edible oil down to very low ppm levels, acting by producing more water-soluble lysophospholipids by splitting off a fatty acid from the phospholipid. However, a side effect of this process is increased production of FFA, which will dilute the micronutrients in the deodorizer distillates. Another type of enzymes commonly know as phospholipase C (“PLC”) type enzymes have also recently been taken into large scale industrial use. These enzymes give increased yields of oil-product by converting phospholipids to DAG. However, the increased level of DAG in the oils tends to aggravate the problem with neutral oils loss during the steam stripping operation since the vapour pressure of DAG is higher than the vapour pressure of TAG.

In recent years some refiners has in their deodorization sections included an additional condensation zone an arrangement often referred to as “double scrubbers” disclosed in U.S. Pat. No. 6,750,359, having an additional scrubber at high temperature. While use of this “double scrubber” enables withdrawal of a sidestream of condensate from the high temperature condensation step enriched in micronutrients, there remains a significant loss of micronutrients in the FFA rich overhead stream. A further significant limitation of such approach is that the separation efficiency in the hot scrubber is closely linked to the operating conditions of the deodorizer, where the main function is to produce edible oil by stripping steam under vacuum. Such linkage will impose rather low limits for the obtainable enrichment for the tocopherols in any distillate stream withdrawn from the hot scrubber. Other methods according to the prior art are disclosed by U.S. Pat. No. 7,598,407 and US2010/0200805.

A further trend in the industry is to move towards de-acidification, i.e. “physical refining” for oils, such as soybean oil, which traditionally are refined by neutralizing the free fatty acids with caustic to form soaps, subsequently separated by water washing. The by-product from this operation, soap stock, is of low value and furthermore leads to oil losses. In the physical refining route the content of FFA to the de-acidification column will increase from about 0.05 to about 0.1 percent by weight (wt %), being FFA contents typical for a neutralized and bleached oil, to the FFA levels in the crude oil, e.g. 0.5 to 1 wt % in the case of soybean oil, or 3 to 6 wt % in the case of palm oil. This will lead to handling of more FFA in the stripping column, also directionally diluting sidestreams enriched in micronutrients.

FFA containing distillates from de-acidification of fats and oils have traditionally been used for soap manufacture, but are to an increasing extent now being used as raw materials for higher value oleo-chemicals, such as higher purity fatty acids produced by fatty acid distillation leading via further conversion to fatty acid esters, fatty alcohols, fatty alcohol sulphates, fatty amines and other oleo-chemical products for e.g. the detergent or cosmetics industry. It is desirable for such processing of the distillates to have as high purity of FFA as possible, which would mean reducing the content of other volatiles such as micronutrients and neutral oils.

Palm oil is always refined using the physical refining method due to the high content of FFA in palm oil, typically the content of FFA is within the range of from about 3 to about 6 wt %. Furthermore, palm oil has a high content of MAG and DAG, the DAG content e.g. typically being in the range of from about 5 to about 7 wt %. Such high content of FFA and volatile neutral oils components leads to much elevated neutral oils loss and dilution of micronutrients in the distillate condensate streams.

The main challenges can therefore be summarized as follows
1. Reduction of neutral oil loss.
2. Recovery of micronutrients with minimal loss and in enriched streams.
3. Increasing the purity of the FFA product stream.

### The Invention

The purpose for the present invention is to find a solution to the above mentioned technical problems and to find a method for reduction of neutral oil loss, recovery of micronutrients with minimal loss recovery of micronutrients in micronutrient enriched streams, and increasing the purity of the FFA product stream. Thus, the present invention relates to a method for treating vegetable oils and/or animal fats comprising the following steps:

(i) feeding an oily feed stream to a vacuum steam stripping column operating at a vacuum level of at least 1 mbar, said oily feed stream comprises volatiles such as free fatty acids, micronutrients and neutral oils such as mixtures of tri-, di- and mono-acylglycerides, stripping off fatty acids together with other volatiles including some neutral oils;

(ii) feeding the stripped off fatty acids, micronutrients together with other volatiles including some neutral oils to a high temperature condensing zone, condensing the neutral oils from vapour phase at an elevated temperature of at least 150° C., retaining and sending back all or some portion of the condensed neutral oils either directly at the feed point of the stripping column in step (i) or indirectly via upstream operations, such as to the bleaching operation and/or to the degumming/neutralisation operation, allowing volatile fatty acids, micronutrients together with other volatiles to pass to cold condensation zone in step (iii) or allowing volatile fatty acids, micronutrients together with other volatiles to pass to a distilling step before the cold condensation zone in step (iii); and

(iii) condensing the volatile fatty acids, micronutrients together with other volatiles in the cold condensation zone at a temperature of at least 25° C., producing a condensate and a stream of stripping steam and of non-condensable gases along with traces of fatty acids and other lighter hydrocarbons vapours, allowing the stream of stripping steam and of non-condensable gases along with traces of fatty acids and other lighter hydrocarbons vapours to continue to vacuum system; and

that the method also comprises obtaining a stream of neutral oils, a fatty acid product stream and a stream enriched in micronutrients.

The vacuum steam stripping column in step (i) may be a packed column or a column with trays or any combination of packing and trays.

The vacuum steam stripping column in step (i) may be operating according to one alternative of the invention within a range from about 1 to about 10 mbar, preferably from about 2 to about 5 mbar vacuum level.

The high temperature condensing zone in step (ii) may be operating according to another alternative of the invention at a temperature within the range from about 150 to about 230° C., preferably at a temperature within the range from about 180 to about 210° C.

The cold temperature condensing zone in step (iii) may be operating according to a further alternative of the invention at a temperature within the range of from about 25 to about 80° C., preferably from about 40 to about 60° C.

The method may also comprise a distillation step (iv) according to an alternative of the invention comprising distilling the condensate from step (iii) in vacuum of at least 0.001 mbar, achieving essentially complete recovery of micronutrients combined with a degree of enrichment, both of which are not achievable simultaneously with prior art. The distillation step will produce a fatty acid product stream and a stream enriched in micronutrients. The vacuum distillation operation in step (iv) may be selected from the group consisting of short-path distillation, wiped-film evaporators, vacuum flash operations, counter-current multistage distillation columns.

The vacuum distillation operation in step (iv) may be operating according to a further alternative of the invention within a pressure range from about 0.001 to about 10 mbar, preferably from about 1 to about 10 mbar, more preferred from about 2 to about 5 mbar.

The method according to one embodiment of the invention may comprise a vacuum distilling step between the high temperature condensation zone in step (ii) and the low temperature condensation zone in step (iii). The between vacuum distilling step may be operating within a pressure range from about 0.001 to about 10 mbar, preferably from about 1 to about 10 mbar, more preferred from about 2 to about 5 mbar.

The new method for treating vegetable oils and/or animal fats provides improved recovery of neutral oils by changing the configuration and operating philosophy of the high temperature condensation stage fundamentally from prior art, which gives a possibility to recover neutral oil while at the same time allowing volatile micronutrients to pass to a recovery and enrichment operation. Another improvement is that micronutrients from the high temperature condensation zone are quickly cooled and quantitatively captured in the cold condensation zone, thus leading to an essentially no-loss operation for the micronutrients. Alternatively, the micronutrients are quantitatively captured in a distillation step before the cold condensation step. A further improvement is enrichment of the recovered micronutrients by applying a vacuum distillation operation at a suitable vacuum level and separation efficiency, which allows the required enrichment of the recovered micronutrients. Micronutrients, especially the tocopherols and tocotrienols, are antioxidants and known to deteriorate during extended storage and transport. The immediate enrichment in the plant has the advantage that it becomes more feasible to package the enriched products in a protective manner to reduce such deterioration. A further advantage of conducting the vacuum distillation in the plant is that the utility supply facilities such as steam, vacuum, electricity, cooling water as well as automation is shared with the main plant. Reducing the presence of neutral oils will greatly assist in the preparation of the enriched micronutrient stream. Furthermore, the vacuum distillation operation in step (iv) and the vacuum distilling step between high temperature condensation step (ii) and low temperature condensation step (iii) may as an overhead product give a FFA stream having an improved purity compared to the produced FFA streams according to prior art.

The method may also comprise that stripping steam, volatile fatty acids, micronutrients together with other volatiles from the high temperature condensate zone is fed to a distillation column, in the distillation column the stream of stripping steam, volatile fatty acids, micronutrients together with other volatiles meets a stream from the cold temperature condensation zone, leading to formation of a reflux of condensate, obtaining a fatty acid product stream.

The method may also comprises that stripping steam, volatile fatty acids, micronutrients together with other volatiles from the high temperature condensate zone is fed to the cold temperature zone, and obtaining a stream enriched in micronutrients from the cold temperature zone.

The method according to the invention may have any combinations of the above mentioned alternatives, and is thus not limited to anyone of the mentioned alternatives. Further aspects and embodiments of the invention are defined by the sub-claims. The invention will be further be illustrated by the accompanying drawings and be presented in the following detailed description of embodiments of the invention. The invention will also be illustrated by the following examples. The below figures and examples are intended to illustrate the invention not to limiting the scope of invention. If not otherwise stated in the examples and tables the percentage is given by percent by weight (wt %).

### BRIEF DESCRIPTION OF THE DRAWINGS

FIG. 1 discloses a simplified diagram of the prior art method according to U.S. Pat. No. 6,750,359 for treating vegetable oils and/or animal fats.

FIG. 2 discloses a method for treating vegetable oils and/or animal fats according to one embodiment of the invention.

FIG. 3 discloses a method for treating vegetable oils and/or animal fats according to an alternative embodiment of the invention.

### DETAILED DESCRIPTION OF THE DRAWINGS

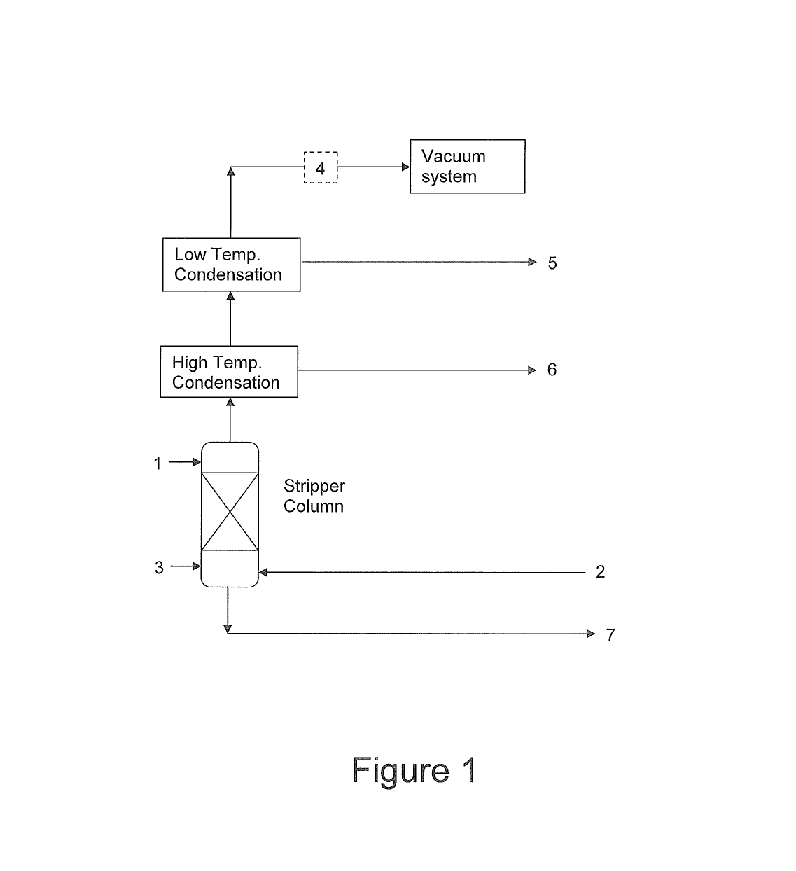

FIG. 1 illustrates one embodiment of prior art wherein an oily feed stream 1 is feed to a vacuum steam stripping column together with stripping steam 2 and in-leakage of air 3. Fatty acids, micronutrients together with other volatiles, and neutral oils are stripped off and transferred to a high temperature condensing zone. At the high temperature condensing zone a stream enriched in micronutrients 6 is condensed and separated off from the feed. The separated feed is further transferred to a cold condensation zone, producing a fatty acid product stream 5 which is condensed, and a stream 4 of steam, non-condensable gases along with traces of fatty acids and other lighter hydrocarbons vapours, allowing stream 4 to continue to vacuum system. From the vacuum steam stripping column is a product neutral oil stream 7 recovered.

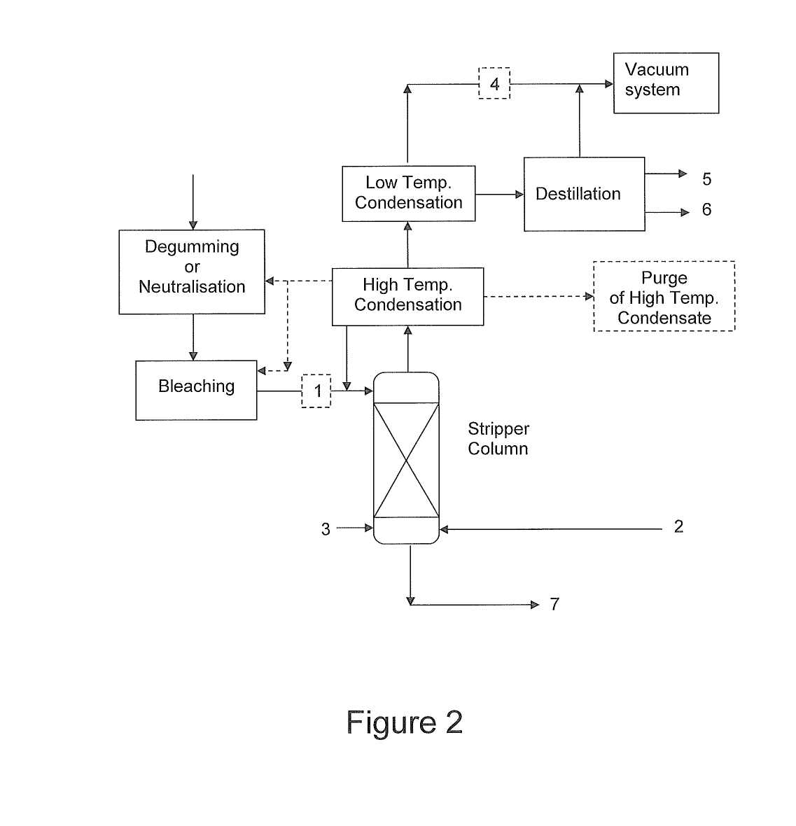

FIG. 2 is showing a method according to one embodiment of the invention. An oily, pretreated feed stream 1 is fed to a vacuum steam stripping column together with stripping steam 2 and in-leakage of air 3. In the vacuum steam stripping column fatty acids, micronutrients together with other volatiles and neutral oils are stripped off and transferred to a high temperature condensing zone in step (ii). At the high temperature condensing zone the neutral oils are condensed from the vapour phase. The condensed neutral oils are retained and sent back to the stripping column either directly, or indirectly via upstream operations, such as to a bleaching operation and/or to degumming/neutralisation operation. Optionally a purge stream of the condensate from the high temperature condensation loop can be taken out as indicated with the dashed line. From the vacuum steam stripping column a neutral oil stream 7 recovered as product

The stripping steam, volatile fatty acids, micronutrients together with other volatiles are allowed to pass to a cold condensation zone. At the cold condensation zone the volatile fatty acids, micronutrients together with other volatiles are condensed. A stream 4 of steam, non-condensable gases along with traces of fatty acids and other lighter hydrocarbons vapours are allowed to continue to the vacuum system.

The condensate of volatile fatty acids, micronutrients together with other volatiles is transferred to a distilling section in step (iv) to separate the condensate into a fatty acid product stream 5, a residual stream 4 of steam, non-condensable gases along with traces of fatty acids and other lighter hydrocarbons vapours, and a stream enriched in micronutrients 6. Residual stream 4 of steam, non-condensable gases along with traces of fatty acids and other lighter hydrocarbons vapours are allowed to continue to the vacuum system. The vacuum distillation operation is selected from the group consisting of short-path distillation, wiped-film evaporators, vacuum flash operations, counter-current multistage distillation columns.

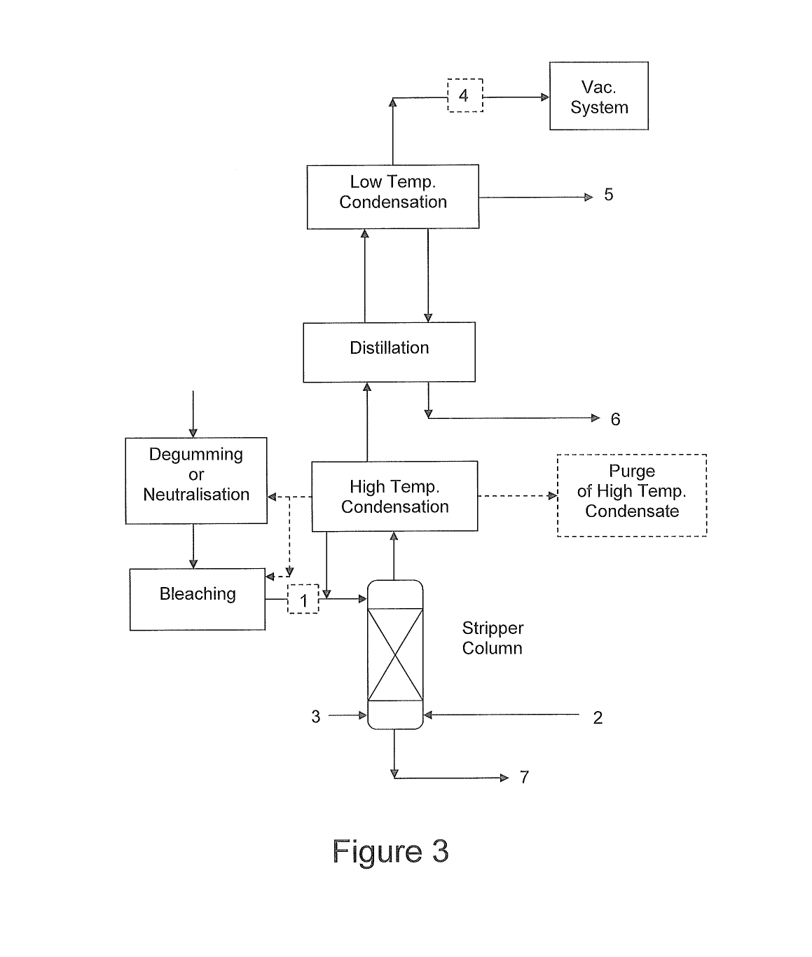

FIG. 3 is showing an alternative embodiment of the invention. According to this embodiment a distillation operation is placed between the high temperature condensation zone in step (ii) and the low temperature condensation zone in step (iii). A pretreated feed of oil stream 1 is fed to a vacuum steam stripping column together with stripping steam 2 and in-leakage of air 3. Fatty acids, micronutrients together with other volatiles, and neutral oils are stripped off in the stripper column, and transferred to the high temperature condensing zone. At the high temperature condensing zone the neutral oils are condensed from the vapour phase. The condensed neutral oils are retained and sent back to the stripping column either directly, or indirectly via upstream operations, such as to bleaching operation and/or to degumming/neutralisation operation. Optionally a purge stream of the condensate from the high temperature condensation loop can be taken out as indicated with the dashed line. From the vacuum steam stripping column a neutral oil stream 7 is recovered as product.

The stripping steam, volatile fatty acids, micronutrients together with other volatiles from the high temperature condensate zone in step (ii) is fed to the distillation column. In the distillation column this stream of volatile components meets a distillate stream being returned from the cold temperature condensation step, leading to formation of a reflux of condensate. The distilling column together with the cold condensation stage will thus separate the stripping steam and volatiles from the high temperature condensation zone into a fatty acid product stream 5 together with a stream 4 of steam, on-condensable gases along with traces of fatty acids and other lighter hydrocarbons vapours, and a stream enriched in micronutrients 6. The stream enriched in micronutrients 6 is collected from the vacuum distilling column. The vacuum distillation operation is selected from the group consisting of short-path distillation, wiped-film evaporators, vacuum flash operations, counter-current multistage distillation columns. The overhead condenser for the distillation column and cold condensation step (iii) may thus be combined in a single operation in this embodiment. According to this embodiment the stripping steam may be forced through an upper rectification section in a counter-current distillation column, and this can lead to added pressure drop and requirement for increased diameters in the stripping, rectification and condensation sections to compensate for this, and/or requirement for a more expensive vacuum system providing a deeper suction pressure. Therefore, the choice between the embodiments of the invention, will depend on the circumstances in a specific design case such as type of oil to be treated, whether a new installation of retrofit to an existing installation.

### EXAMPLES

### Comparative Example

In this comparative test were the oils fed to the stripper column at 260° C. and 1% steam is applied for stripping, according to the method shown in FIG. 1. The high temperature condensation is taking place at 170° C. and the low temperature condensation at 55° C., in both cases simulated by scrubbing the vapours with a condensate at those temperature levels. The vacuum level at the top of the cold condensation stage was 2.3 mbar. The mass balance was established using a process simulator (PRO/II from SimSci-Esscor) combined with a proprietary Alfa Laval property database for lipids. The results are shown in Table 1.

TABLE 1

| | Stream | | | | | | |
|---|---|---|---|---|---|---|---|
| | 1 | 2 | 3 | 4 | 5 | 6 | 7 |
| | Flow [kg/hr] | | | | | | |
| Composition [wt %] | 41666.7 | 437.0 | 10.0 | 467.1 | 272.4 | 128.1 | 41260.0 |
| TAG | 96.7625 | — | — | — | 0.0011 | 11.9955 | 97.7122 |
| DAG | 1.8000 | — | — | — | 0.2169 | 25.4838 | 1.7378 |
| MAG | 0.0500 | — | — | 0.0001 | 4.9954 | 3.9431 | 0.0053 |
| FFA | 0.6000 | — | — | 0.0381 | 89.0850 | 5.3519 | 0.0006 |
| Tocopherols | 0.1350 | — | — | — | 2.4985 | 20.1158 | 0.0574 |
| Sterols | 0.6000 | — | — | — | 2.9684 | 32.9213 | 0.4843 |
| Squalene | 0.0025 | — | — | — | 0.0955 | 0.1851 | 0.0013 |
| Water | 0.0500 | 100.00 | — | 97.8210 | 0.1392 | 0.0036 | 0.0012 |
| Air | — | — | 100.00 | 2.1408 | — | — | — |
| Σ | 100.00 | 100.00 | 100.00 | 100.00 | 100.00 | 100.00 | 100.00 |

The mass balance deviation was 0.011 kg/hr.

### Example of the Invention

In this example was the high temperature condensation stage operating at 185° C., according to the method shown in FIG. 2. A multistage distillation column was used to produce the enriched micronutrient stream 6. The distillation column has 3 equilibrium stages, a reboiler and a condenser was simulated with a condenser pressure of 2 mbar. Reboiler temperature was 204° C. and the condenser operated at the bubble point of 42° C. The target purity of the micronutrient product was set at 20 wt % tocopherol in this example.

All other conditions was kept as in the example above of the background art, except the steam stripping columns were adjusted slightly to target the same concentration of tocopherol in the product oil stream 7.

It is apparent from the example the virtual absence of tri-acylglycerides, i.e. TAG, and the very low content of di-acylglycerides, i.e. DAG, in the micronutrient product 6. The FFA product had complete absence of TAG and DAG and only traces of mono-acylglycerides, i.e. MAG. The effect of the new configuration of the hot condensation stage has reduced the neutral oil loss from 67 kg/hr to only 23 kg/hr.

The new configuration shows virtually no loss of tocopherols or other micronutrients to the FFA product stream, the loss of tocopherols being less than 0.03 wt % of the tocopherols in the feed stream, which is about 16 grams per hour. The overall test results are shown in Table 2

TABLE 2

| | Stream | | | | | | |
|---|---|---|---|---|---|---|---|
| | 1 | 2 | 3 | 4 | 5 | 6 | 7 |
| | Flow [kg/hr] | | | | | | |
| Composition [wt %] | 41666.7 | 437.0 | 10.0 | 467.1 | 194.8 | 162. | 41289.1 |
| TAG | 96.7625 | — | — | — | — | 0.0088 | 97.6473 |
| DAG | 1.8000 | — | — | — | — | 1.8527 | 1.8092 |
| MAG | 0.0500 | — | — | — | 0.1247 | 12.1728 | 0.0019 |
| FFA | 0.6000 | — | — | 0.0320 | 99.6104 | 34.2555 | 0.0002 |
| Tocopherols | 0.1350 | — | — | — | 0.0081 | 20.0000 | 0.0574 |
| Sterols | 0.6000 | — | — | — | 0.0063 | 31.3615 | 0.4819 |
| Squalene | 0.0025 | — | — | — | 0.0005 | 0.3487 | 0.0011 |
| Water | 0.0500 | 100.00 | — | 97.8268 | 0.2499 | — | 0.0011 |
| Air | — | — | 100.00 | 2.1411 | — | — | — |
| Σ | 100.00 | 100.00 | 100.00 | 100.00 | 100.00 | 100.00 | 100.00 |

The mass balance deviation was 0.002 kg/hr.

Recalculated to annual losses (at 330 operating days per year) this corresponds to a loss of 126 kg/of tocopherols and 183 ton/yr of neutral oil. In monetary terms these losses therefore translates to 4300 $/yr tocopherol value and 0.22 mill $/yr neutral oil losses, total of about 0.22 mill $ lost per year. Compared to the loss of 2.5 mill $/year applying the prior art we find that the invention recovers about 90% of the value of those losses.

1. A method for treating vegetable oils and/or animal fats comprising:
(i) feeding an oily feed stream to a vacuum steam stripping column operating at a vacuum level of at least 1 mbar, said oily feed stream comprising (a) volatiles, said volatiles comprising volatile fatty acids and other volatiles, (b) micronutrients and (c) neutral oils, and stripping off components comprising volatiles, micronutrients and neutral oils;
(ii) feeding the stripped off components to a high temperature condensing zone, condensing the neutral oils from vapour phase at an elevated temperature of at least 150° C., obtaining condensed neutral oils, retaining and returning all or some portion of the condensed neutral oils directly or indirectly to the vacuum steam stripping column, and allowing steam, volatile fatty acids, other volatiles, and micronutrients to pass to a cold condensation zone in step (iii) or allowing steam, volatile fatty acids, other volatiles and micronutrients to be fed to a distilling column in a distilling step before the cold condensation zone in step (iii);
(iii) condensing the volatile fatty acids, other volatiles and micronutrients in the cold condensation zone at a temperature of at least 25° C., obtaining a condensate comprising volatile fatty acids, other volatiles and micronutrients and a stream comprising steam, non-condensable gases, traces of fatty acids and other lighter hydrocarbons vapours, and allowing said stream to continue to vacuum system; and
that the method also comprises obtaining a neutral oils product stream, a fatty acid product stream and a micronutrients product stream.

2. The method according to claim 1, wherein the method also comprises a distilling step (iv) comprising feeding the condensate from the cold condensation zone to a distilling column and distilling in vacuum of at least 0.001 mbar, and obtaining the fatty acid product stream and the micronutrients product stream.

3. The method according to claim 2, wherein the distilling column is selected from the group consisting of short-path distillation, wiped-film evaporators, one or more subsequent vacuum flash operations, counter-current multistage distillation columns.

4. The method according to claim 2, wherein the vacuum distillation operation in step (iv) is operated within a range from about 1 to about 10 mbar.

5. The method according to claim 1, wherein the vacuum steam stripping column in step (i) is operated within a range from about 1 to about 10 mbar.

6. The method according to claim 1, wherein the high temperature condensing zone in step (ii) is operated at a temperature within the range from about 150 to about 230° C.

7. The method according to claim 1, wherein the cold temperature condensing zone in step (iii) is operated at a temperature within the range of from about 25 to about 80° C.

8. The method according to claim 1, wherein a stream of neutral oils product stream is collected from the vacuum steam stripping column in step (i).

9. The method according to claim 1, wherein the cold condensation zone in step (iii) provides a cold reflux stream which is sent to the distillation column.

10. The method according to claim 1, wherein the method also comprises feeding a stream comprising steam, volatile fatty acids, other volatiles, and micronutrients stripped from the high temperature condensate zone to a distillation column, wherein in the distillation column the fed stream meets a stream from the cold temperature condensation zone, leading to formation of a reflux of condensate, and obtaining the fatty acid product stream.

11. The method according to claim 1, wherein the method also comprises feeding a stream comprising steam, volatile fatty acids, other volatiles, and micronutrients from the high temperature condensate zone to the cold temperature zone, and obtaining the micronutrients product stream from the cold temperature zone.

12. The method according to claim 1, wherein said volatile fatty acids comprise free fatty acids.

13. The method according to claim 1, wherein said neutral oils comprise one or more of tri-, di- and mono-acylglycerides.

14. The method according to claim 1, wherein all or some portion of the condensed neutral oils are indirectly returned to the high temperature condensing zone after being subjected to one or more of a bleaching operation, a degumming operation or a neutralisation operation.

15. A method for treating vegetable oils and/or animal fats comprising:
(i) feeding an oily feed stream to a vacuum steam stripping column operating at a vacuum level of at least 1 mbar, said oily feed stream comprising volatile fatty acids, micronutrients and neutral oils, and stripping off a first stream comprising volatile fatty acids, micronutrients and neutral oils;
(ii) feeding the first stream to a high temperature condensing zone, and condensing the neutral oils from vapour phase at an elevated temperature of at least 150° C. to obtain a first condensate comprising neutral oils, and obtaining a second stream comprising steam, volatile fatty acids, and micronutrients; and
(iii) feeding the second stream into a cold condensation zone that is operated at a temperature of at least 25° C., and obtaining a second condensate comprising volatile fatty acids and micronutrients and a third stream comprising steam, non-condensable gases, traces of fatty acids and other lighter hydrocarbons vapours, wherein the second stream is optionally fed into a distilling column prior to the cold condensation zone;
wherein the method further comprises obtaining a neutral oils product stream, a fatty acid product stream and a micronutrients product stream.

16. The method according to claim 15, further comprising feeding all or a portion of said first condensate comprising neutral oils obtained from the high temperature condensing zone into the vacuum steam stripping column, and collecting said neutral oils product stream from said vacuum steam stripping column.

17. The method according to claim 15, further comprising feeding the second condensate comprising volatile fatty acids and micronutrients obtained from the cold condensation zone to a distilling column, distilling in a vacuum of at least 0.001 mbar and obtaining said fatty acid product stream and said micronutrients product stream from said distilling column.

18. The method according to claim 15, further comprising feeding the second stream comprising steam, volatile fatty acids, and micronutrients into a distilling column prior to the cold condensation zone, and feeding the second condensate comprising volatile fatty acids and micronutrients obtained from the cold condensation zone to the same distilling column and conducting a reflux of condensate to obtain the fatty acid product stream from the distilling column.

19. The method according to claim 15, further comprising feeding the second stream comprising steam, volatile fatty acids, and micronutrients obtained from the high temperature condensate zone to the cold temperature zone, and obtaining the micronutrients product stream from the cold temperature zone.

20. The method according to claim 15, further comprising feeding the third stream obtained from the cold condensation zone to a vacuum system.
